(19) United States
(12) Patent Application Publication
(10) Pub. No.: US 2025/0266189 A1
(43) Pub. Date: Aug. 21, 2025

(54) PROTECTIVE GLASS FILM

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP); Koichi YAMADA, Nagaokakyo-shi (JP); Kojiro TOKIEDA, Nagaokakyo-shi (JP); Miki SASAKI, Nagaokakyo-shi (JP)

(73) Assignee: Murata Manufacturing Co., Ltd., Nagaokakyo-shi (JP)

(21) Appl. No.: 19/189,284

(22) Filed: Apr. 25, 2025

Related U.S. Application Data
(63) Continuation of application No. PCT/JP2023/027445, filed on Jul. 26, 2023.

(30) Foreign Application Priority Data
Nov. 11, 2022 (JP) 2022-180944

(51) Int. Cl. H01C 1/02; H01C 1/14; H01C 1/148; H01C 7/04; H01F 27/02

(52) U.S. Cl. CPC H01C 1/02; H01C 1/1413; H01C 1/148; H01C 7/04; H01F 27/022

(57) ABSTRACT

An electronic component includes a base body and a glass film which covers an outer surface of the base body. The glass film contains one or more elements selected from an alkali metal and an alkaline earth metal as an additive. The glass film has a thickness of 80 nm or more and 5000 nm or less. A ratio of an arithmetic average roughness of an outer surface of the glass film to an arithmetic average roughness of the outer surface of the base body is 0.0002 or more and 0.85 or less.

### CROSS-REFERENCE TO RELATED APPLICATIONS

This application is a continuation of and claims priority to PCT/JP2023/027445, filed on Jul. 26, 2023. PCT/JP2023/027445 claims priority to JP 2022-180944, filed on Nov. 11, 2022. The content of both are hereby incorporated by reference in their entirety.

### TECHNICAL FIELD

The present disclosure relates to an electronic component.

### BACKGROUND

The electronic component described in Patent Document 1 includes a base body, a glass film, and an external electrode. The base body is made of ceramics. The external electrode covers both end surfaces of the base body. In addition, the glass film covers the side surface of the base body. The thickness of the glass film is as thin as about 0.05 to 0.2 μm. Therefore, the surface roughness of the outer surface of the glass film is substantially equal to the surface roughness of the outer surface of the base body.

### PATENT DOCUMENT

Patent Document 1: Japanese Patent No. 5471586

### SUMMARY

An electronic component according to the present disclosure includes a base body; and a glass film covering an outer surface of the base body, wherein the glass film contains one or more elements selected from an alkali metal and an alkaline earth metal as an additive, the glass film has a thickness of 80 nm or more and 5000 nm or less, and a ratio of an arithmetic average roughness of an outer surface of the glass film to an arithmetic average roughness of the outer surface of the base body is 0.0002 or more and 0.85 or less.

### BRIEF DESCRIPTION OF THE DRAWINGS

FIG. 1 is a perspective view of an electronic component.

FIG. 2 is a side view of an electronic component.

FIG. 3 is a sectional view along the line 3-3 in FIG. 2.

FIG. 4 is an enlarged sectional view of the outer surface of a base body and the outer surface of a glass film.

FIG. 5 is an enlarged sectional view of the vicinity of a recess of an electronic component.

FIG. 6 is an explanatory diagram illustrating the method for manufacturing an electronic component.

FIG. 7 is an explanatory diagram illustrating the method for manufacturing an electronic component.

FIG. 8 is an explanatory diagram illustrating the method for manufacturing an electronic component.

FIG. 9 is an explanatory diagram illustrating the method for manufacturing an electronic component.

FIG. 10 is an explanatory diagram illustrating the method for manufacturing an electronic component.

FIG. 11 is an explanatory diagram illustrating the method for manufacturing an electronic component.

FIG. 12 is an explanatory diagram illustrating the method for manufacturing an electronic component.

FIG. 13 is a table showing comparison results of the electronic components between Examples and Comparative Examples.

### DETAILED DESCRIPTION

In a conventional electronic component, a glass film is preferably as thin as possible from the viewpoint of, for example, ensuring conductivity between the internal electrode and the external electrode and reducing the dimension of the electronic component. However, when a thinned glass film is easily damaged, for example, cracked and chipped, when the electronic component is rubbed against another object.

The inventors have developed technology of the present disclosure to address issues with conventional electronic components. In accordance with the present disclosure, an outer surface of a glass film is smooth compared to an outer surface of a base body. Therefore, when the outer surface of the glass film is rubbed against another object, there is reduced frictional force on the outer surface of the glass film. Therefore, the glass film is less likely to be damaged, for example, cracked and chipped. On the other hand, the outer surface of the base body is rougher than the outer surface of the glass film. Therefore, sufficient adhesion force is obtained between the base body and the glass film.

When the glass film is thinned, the glass film is hardly damaged, and sufficient adhesion force is obtained between the base body and the glass film.

### Electronic Component

Hereinafter, an electronic component will be described with reference to the drawings. It is to be noted that components may be shown in an enlarged manner for easy understanding in the drawings. In some cases, the dimension ratio of a component differs from an actual dimension ratio or a dimension ratio in another drawing.

### Overall Configuration

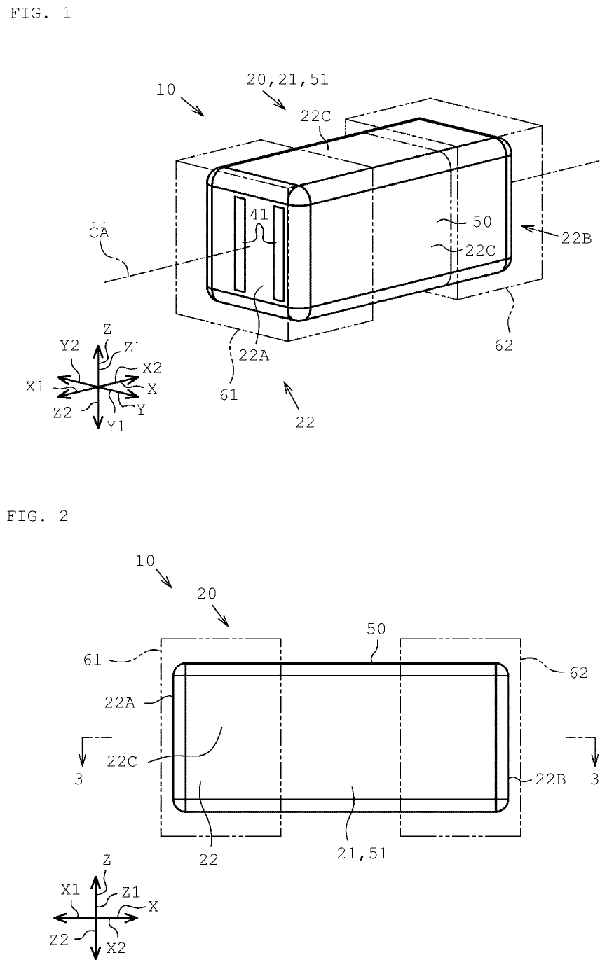

As shown in FIG. 1, an electronic component 10 is, for example, a surface-mount negative-characteristic thermistor component to be mounted on a circuit board or the like. The negative-characteristic thermistor component has a characteristic that the resistance value decreases as the temperature increases.

The electronic component 10 includes a base body 20. The base body 20 has a substantially quadrangular prism shape and has a central axis CA. Hereinafter, an axis extending along the central axis CA is defined as a first axis X. In addition, one of axes that are orthogonal to the first axis X is defined as a second axis Y. Further, an axis that is orthogonal to the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Further, one of the directions along the third axis Z is defined as a third positive direction Z1, and a direction opposite to the third positive direction Z1, of the directions along the third axis Z, is defined as a third negative direction Z2.

An outer surface 21 of the base body 20 has six planar surfaces 22. It is to be noted that the term “surface” of the base body 20 as used herein refers to a part that can be observed as a surface when the whole base body 20 is observed. That is, for example, if there are minute irregularities or steps that cannot be found unless a part of the base body 20 is enlarged and observed with a microscope or the like, the surface is expressed as a planar surface or a curved surface. The six planar surfaces 22 face in directions different from each other. The six planar surfaces 22 are roughly divided into a first end surface 22A that faces in the first positive direction X1, a second end surface 22B that faces in the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

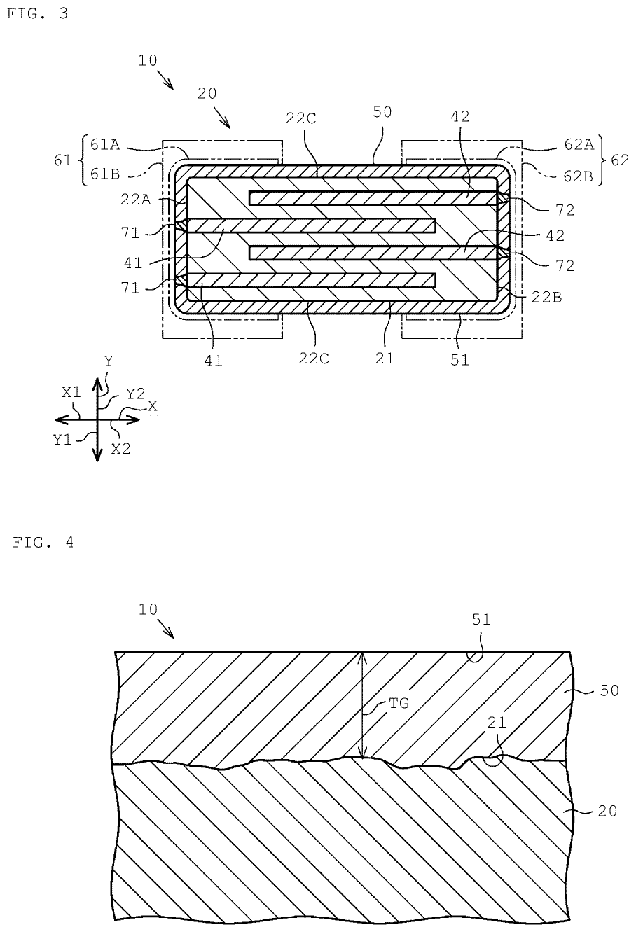

In the outer surface 21 of the base body 20, a boundary portion between two adjacent planar surfaces 22 and a boundary portion between three adjacent surfaces are curved surfaces. That is, the corners of the base body 20 are R-chamfered. It is to be noted that the outer surface 51 of a glass film 50 to be described later is designated by the same reference numerals as with the outer surface 21 of the base body 20 in FIGS. 1 and 2.

As illustrated in FIG. 2, the base body 20 has a dimension in the direction along the first axis X larger than a dimension in the direction along the third axis Z. In addition, as shown in FIG. 1, the base body 20 has a dimension in the direction along the first axis X larger than a dimension in the direction along the second axis Y. The material of the base body 20 is a ceramic obtained by firing a metal oxide containing one or more selected from Mn, Fe, Ni, Co, Ti, Ba, Al, and Zn as a component.

As shown in FIG. 3, the electronic component 10 includes two first internal electrodes 41 and two second internal electrodes 42. The first internal electrodes 41 and the second internal electrodes 42 are embedded in the base body 20.

The material of the first internal electrode 41 is a conductive material. For example, the material of the first internal electrode 41 is palladium. The material of the second internal electrode 42 is the same as the material of the first internal electrode 41.

The first internal electrode 41 has a rectangular plate shape. The first internal electrode 41 has a main surface that is orthogonal to the second axis Y. The second internal electrode 42 has the same rectangular plate shape as the first internal electrode 41. The second internal electrode 42 has a main surface orthogonal to the second axis Y, as with the first internal electrode 41.

The dimension of the first internal electrode 41 in the direction along the first axis X is smaller than the dimension of the base body 20 in the direction along the first axis X. In addition, as shown in FIG. 1, the dimension of the first internal electrode 41 in the direction along the third axis Z is approximately ⅔ of the dimension of the base body 20 in the direction along the third axis Z. The dimension of the second internal electrode 42 in each of the directions is the same as that of the first internal electrode 41.

As shown in FIG. 3, the first internal electrodes 41 and the second internal electrodes 42 are located in a staggered manner in the direction along the second axis Y. That is, the first internal electrode 41, the second internal electrode 42, the first internal electrode 41, and the second internal electrode 42 are arranged in this order from the side surface 22C facing the second positive direction Y1 toward the second negative direction Y2. Thus, the distances between the respective internal electrodes in the direction along the second axis Y are equal to each other.

As illustrated in FIG. 1, the two first internal electrodes 41 and the two second internal electrodes 42 are both located at the center of the base body 20 in the direction along the third axis Z. On the other hand, as shown in FIG. 3, the first internal electrodes 41 are located to be shifted in the first positive direction X1. The second internal electrodes 42 are located to be shifted in the first negative direction X2.

Specifically, the end of the first internal electrode 41 on the first positive direction X1 side coincides with the end of the base body 20 on the first positive direction X1 side. The end of the first internal electrode 41 on the first negative direction X2 side is located inside the base body 20, without reaching the end of the base body 20 on the first negative direction X2 side. On the other hand, the end of the second internal electrode 42 on the first negative direction X2 side coincides with the end of the base body 20 on the first negative direction X2 side. The end of the second internal electrode 42 on the first positive direction X1 side is located inside the base body 20, without reaching the end of the base body 20 on the first positive direction X1 side.

As illustrated in FIG. 3, the electronic component 10 includes a glass film 50. The glass film 50 covers the outer surface 21 of the base body 20. That is, the glass film 50 covers the substantially whole region of the outer surface 21 of the base body 20. The main material of the glass film 50 is insulating glass. Therefore, the glass film 50 contains silicon dioxide. In addition, the glass film 50 contains, as an additive, one or more elements selected from an alkali metal and an alkaline earth metal. Specifically, the glass film 50 contains potassium as an additive. The value of “K/Si”, which is the ratio of potassium to silicon contained in the glass film 50, is 0.5 atm % or more and 90 atm % or less. Specifically, the ratio of potassium to silicon contained in the glass film 50 is about 30 atm %.

The electronic component 10 includes a first external electrode 61 and a second external electrode 62. The first external electrode 61 includes a first underlying electrode 61A and a first metal layer 61B. The first underlying electrode 61A is stacked on the glass film 50 at a part of the outer surface 21 of the base body 20, including the first end surface 22A. Specifically, the first underlying electrode 61A is a five-face electrode that covers the first end surface 22A of the base body 20 and a portion of four side surfaces 22C on the first positive direction X1 side. The material of the first underlying electrode 61A is silver and glass.

The first metal layer 61B covers the first underlying electrode 61A from the outside. Therefore, the first metal layer 61B is stacked on the first underlying electrode 61A. The first metal layer 61B has a two-layer structure of a nickel layer and a tin layer in this order from the first underlying electrode 61A side.

The second external electrode 62 includes a second underlying electrode 62A and a second metal layer 62B. The second underlying electrode 62A is stacked on the glass film 50 at a part of the outer surface 21 of the base body 20, including the second end surface 22B. Specifically, the second underlying electrode 62A is a five-face electrode that covers the second end surface 22B of the base body 20 and a portion of four side surfaces 22C on the first negative direction X2 side. The material of the second underlying electrode 62A is the same as the material of the first external electrode 61, and is a mixture of silver and glass.

The second metal layer 62B covers the second underlying electrode 62A from the outside. More specifically, the second metal layer 62B is stacked on the second underlying electrode 62A. The second metal layer 62B has, as with the first metal layer 61B, a two-layer structure of nickel plating and tin plating in this order from the side of the base body 20.

The second external electrode 62 is, without reaching the first external electrode 61 on the side surface 22C, disposed away from the first external electrode 61 in the direction along the first axis X. Further, on the side surface 22C of the base body 20, the first external electrode 61 and the second external electrode 62 are not stacked with the glass film 50 exposed at the central part in the direction along the first axis X. It is to be noted that the first external electrode 61 and the second external electrode 62 are indicated by two-dot chain lines in FIGS. 1 to 3.

As illustrated in FIG. 3, the first external electrode 61 and the end of the first internal electrode 41 on the first positive direction X1 side are connected via a first penetrating part 71 penetrating the glass film 50. Although details will be described later, the first penetrating part 71 is formed by extension of palladium constituting the first internal electrode 41 toward the first external electrode 61 in the process of manufacturing the electronic component 10.

The second external electrode 62 and the end of the second internal electrode 42 on the first negative direction X2 side are connected via a second penetrating part 72 penetrating the glass film 50. The second penetrating part 72 is also, as with the first penetrating part 71, formed by extension of palladium constituting the second internal electrode 42 toward the second external electrode 62 in the process of manufacturing the electronic component 10. While the first internal electrode 41 and the first penetrating part 71 are illustrated as separate members with a boundary in FIG. 3, there is actually no clear boundary therebetween. In this respect, the same applies to the second penetrating part 72.

### Thickness of Glass Film

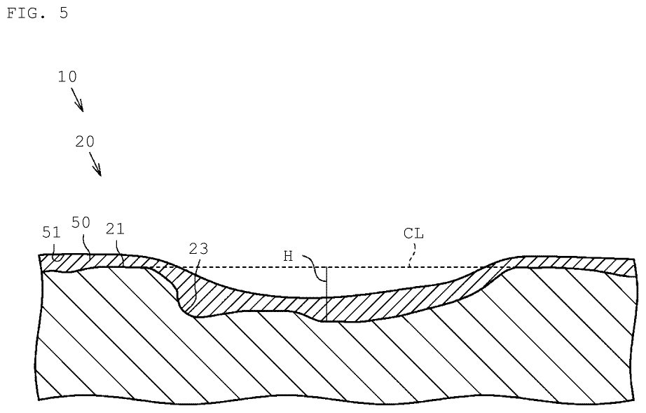

As illustrated in FIG. 4, the shortest distance from the outer surface 21 of the base body 20 to the outer surface 51 of the glass film 50 is defined as the thickness TG of the glass film 50. The average value of the thickness TG of the glass film 50 is 80 nm or more and 5000 nm or less. Specifically, the average value of the thickness TG of the glass film 50 is 1200 nm. The average value of the thickness TG of the glass film 50 is calculated as follows.

First, in the outer surface 21 of the base body 20, a portion where there is no recess 23 caused by falling off of ceramic grains, cracking and chipping of the base body 20, and the like is specified. Next, the section of the base body 20 at the portion is captured with an electron microscope. For this captured image, a range of at least 10 μm or more in a direction along the outer surface 51 of the glass film 50 is defined as a measurement range. Then, the sectional area of the glass film 50 in the measurement range is calculated by image processing. Then, by dividing the sectional area of the glass film 50 in the measurement range by the length of the measurement range in the direction along the outer surface 51 of the glass film 50, the average value of the thickness TG of the glass film 50 is calculated. That is, the average value of the thickness TG of the glass film 50 is an average value of the thickness TG in the measurement range.

The recess 23 having a maximum depth H that is 10 times or more the arithmetic average roughness of the outer surface 21 of the base body 20 is defined as the above-described recess 23 caused by falling off of ceramic grains, cracking and chipping of the base body 20, and the like. The maximum depth H of the recess 23 is calculated as follows. First, the base body 20 is ground in a direction orthogonal to the outer surface 21 by focused ion beam processing. The ground section of the base body 20 is captured. Then, as illustrated in FIG. 5, on the section, a tangent line CL is drawn so that the tangent line CL is circumscribed to both of the outer surfaces 21, which sandwich the recess 23 and are present on both sides thereof. At this time, a part of the tangent line CL may coincide with the outer surface 21. At this time, the depth of the recess 23 is the length from the tangent line CL to the inner surface of the recess 23 in the direction orthogonal to the tangent line CL circumscribing the outer surface 21.

Next, by focused ion beam processing, the base body 20 is ground from the above ground section by a predetermined capturing pitch. The capturing pitch of the focused ion beam processing is, for example, 10 nm. Then, the new ground section of the base body 20 is captured, and the maximum depth of the same recess 23 is measured on the new section. In this way, grinding and measuring the maximum depth of the recess 23 are repeated. Among the maximum depths in each ground section obtained in this manner, the largest value is defined as the maximum depth H in the entire recess 23. That is, the maximum depth H of the recess 23 herein is the depth at the deepest portion of the recess 23.

### Arithmetic Average Roughness of Each Outer Surface of Glass Film and Base Body

The arithmetic average roughness of the outer surface 51 of the glass film 50 is 0.1 nm or more and 5 nm or less. Specifically, the arithmetic average roughness of the outer surface 51 of glass film 50 is 5 nm. The arithmetic average roughness of the outer surface 51 of the glass film 50 is calculated as follows. First, by the above-described method, in the outer surface 21 of the base body 20, a portion where there is no recess 23 caused by falling off of ceramic grains, cracking and chipping of the base body 20, and the like is specified. In the portion, a range of at least 10 μm or more in a linear direction along the outer surface 21 of the base body 20 is defined as a measurement range. For the measurement range, the arithmetic average roughness of the glass film 50 is measured using a laser microscope.

The arithmetic average roughness of the outer surface 21 of the base body 20 is 5.9 nm or more and 500 nm or less. Specifically, the arithmetic average roughness of the outer surface 21 of the base body 20 is 70 nm. The arithmetic average roughness of the outer surface 21 of the base body 20 is calculated as follows. First, the glass film 50 is removed from the electronic component 10 using an alkaline aqueous solution or the like that dissolves the glass film 50 and does not dissolve the base body 20. Then, similarly to the measurement of the arithmetic average roughness of the outer surface 51 of the glass film 50, a portion where there is no recess 23 caused by falling off of ceramic grains, cracking and chipping of the base body 20, and the like is specified. In the portion, a range of at least 10 μm or more in a linear direction along the outer surface 21 of the base body 20 is defined as a measurement range. For the measurement range, the arithmetic average roughness of the base body 20 is measured using a laser microscope. The base body 20 is formed by barrel polishing in the R chamfering step S12 described later. Therefore, the roughness is substantially constant in the entire outer surface 21 of the base body 20, excluding the recess 23 caused by falling off of ceramic grains, cracking and chipping of the base body 20, and the like.

The ratio of the arithmetic average roughness of the outer surface 51 of the glass film 50 is 0.0002 or more and 0.85 or less with respect to the arithmetic average roughness of the outer surface 21 of the base body 20. Specifically, the ratio is about 0.07.

### Method for Manufacturing Electronic Component

Next, the method for manufacturing the electronic component 10 will be described.

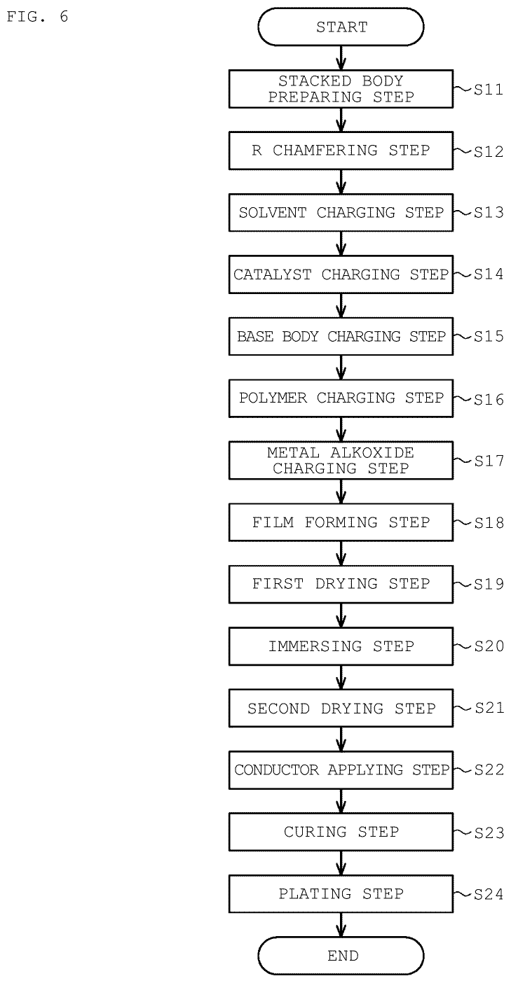

As illustrated in FIG. 6, the method for manufacturing the electronic component 10 includes a stacked body preparing step S11, a R chamfering step S12, a solvent charging step S13, a catalyst charging step S14, a base body charging step S15, a polymer charging step S16, and a metal alkoxide charging step S17. In addition, the method for manufacturing the electronic component 10 further includes a film forming step S18, a first drying step S19, an immersing step S20, a second drying step S21, a conductor applying step S22, a curing step S23, and a plating step S24.

First, in forming the base body 20, a stacked body that is a cuboid base body 20 having six planar surfaces 22 is prepared in the stacked body preparing step S11. That is, the stacked body at this stage is in a state before R chamfering. For example, first, a plurality of ceramic sheets to serve as the base body 20 are provided. The sheet has a thin plate shape. On the sheet, a conductive paste to serve as the first internal electrode 41 is stacked. On the stacked paste, the ceramic sheet to serve as the base body 20 is stacked. On the sheet, a conductive paste to serve as the second internal electrode 42 is stacked. In this manner, the ceramic sheet and the conductive paste are stacked. Then, an unfired stacked body is formed by cutting into a predetermined size. Thereafter, the unfired stacked body is subjected to firing at a high temperature to provide a stacked body.

Next, as illustrated in FIG. 6, the R chamfering step S12 is performed. In the R chamfering step S12, a curved surface is formed at a boundary portion between two adjacent planar surfaces 22 and a boundary portion between three adjacent planar surfaces 22 of the stacked body prepared in the stacked body preparing step S11. For example, the corner of the stacked body is subjected to R chamfering by barrel polishing, whereby a curved surface is formed at the boundary portion.

Next, as shown in FIG. 6, the solvent charging step S13 is performed. As illustrated in FIG. 7, in the solvent charging step S13, 2-propanol is charged as a solvent 82 into a reaction vessel 81.

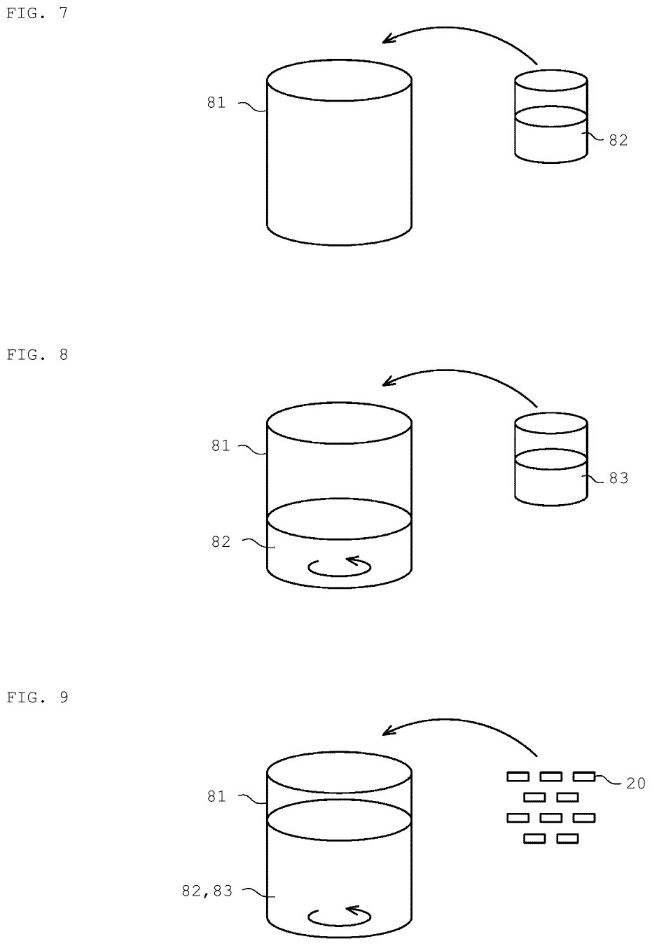

Next, as shown in FIG. 6, the catalyst charging step S14 is performed. As illustrated in FIG. 8, in the catalyst charging step S14, first, stirring of the solvent 82 in the reaction vessel 81 is started. Then, ammonia water is charged into the reaction vessel 81 as an aqueous solution 83 containing the catalyst. The catalyst, which is a hydroxide ion, functions as a catalyst that promotes hydrolysis of a metal alkoxide 85 described later.

Next, as illustrated in FIG. 6, the base body charging step S15 is performed. As illustrated in FIG. 9, in the base body charging step S15, the plurality of base bodies 20 formed in advance in the R chamfering step S12 as described above are charged into the reaction vessel 81.

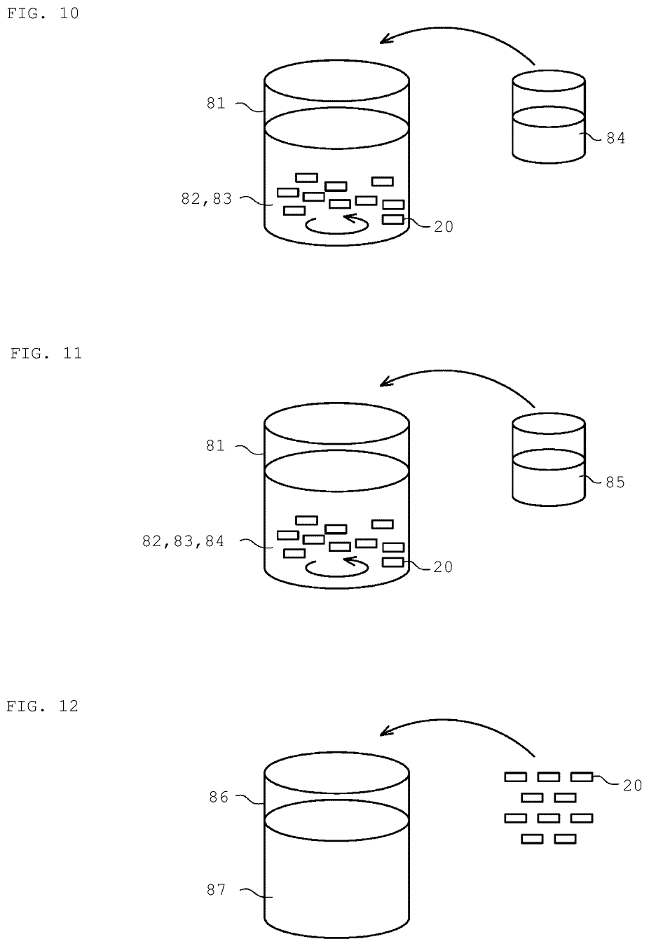

Next, as illustrated in FIG. 6, the polymer charging step S16 is performed. As illustrated in FIG. 10, in the polymer charging step S16, polyvinylpyrrolidone is charged as a polymer 84 into the reaction vessel 81. Thus, the polymer 84 put into the reaction vessel 81 adsorbs to the outer surfaces 21 of the base bodies 20.

Next, as illustrated in FIG. 6, the metal alkoxide charging step S17 is performed. As illustrated in FIG. 11, in the metal alkoxide charging step S17, tetraethyl orthosilicate in a liquid state is charged as the metal alkoxide 85 into the reaction vessel 81. Tetraethyl orthosilicate is sometimes referred to as tetraethoxysilane. The amount of the metal alkoxide 85 to be charged in the metal alkoxide charging step S17 is calculated based on the area of the outer surface 21 of the base bodies 20 charged in the base body charging step S15. Specifically, the calculation is performed by multiplying the amount of the metal alkoxide 85 per base body 20, required for forming the glass film 50 covering the outer surface 21 of the base body 20, by the number of base bodies 20.

Next, as illustrated in FIG. 6, the film forming step S18 is performed. In the film forming step S18, the stirring of the solvent 82 started in the solvent charging step S13 described above is continued for a predetermined time after the metal alkoxide 85 is charged into the reaction vessel 81 in the metal alkoxide charging step S17. Thus, the metal alkoxide 85 is hydrolyzed with the hydroxide ion as a catalyst. When the metal alkoxide 85 is hydrolyzed, the hydrolyzed metal alkoxide 85 adheres to the surfaces of the base bodies 20. Then, the metal alkoxides 85 adhering to the surfaces of the base bodies 20 are dehydrated and condensed to form the glass film 50. In the film forming step S18, the glass film 50 in a sol form is formed by a liquid phase reaction in the reaction vessel 81.

Next, as shown in FIG. 6, the first drying step S19 is performed. In the first drying step S19, the base bodies 20 are, after the film forming step S18, taken out from the reaction vessel 81 and then dried. Thus, the glass film 50 in a sol form is dried to become a glass film 50 in a gel form.

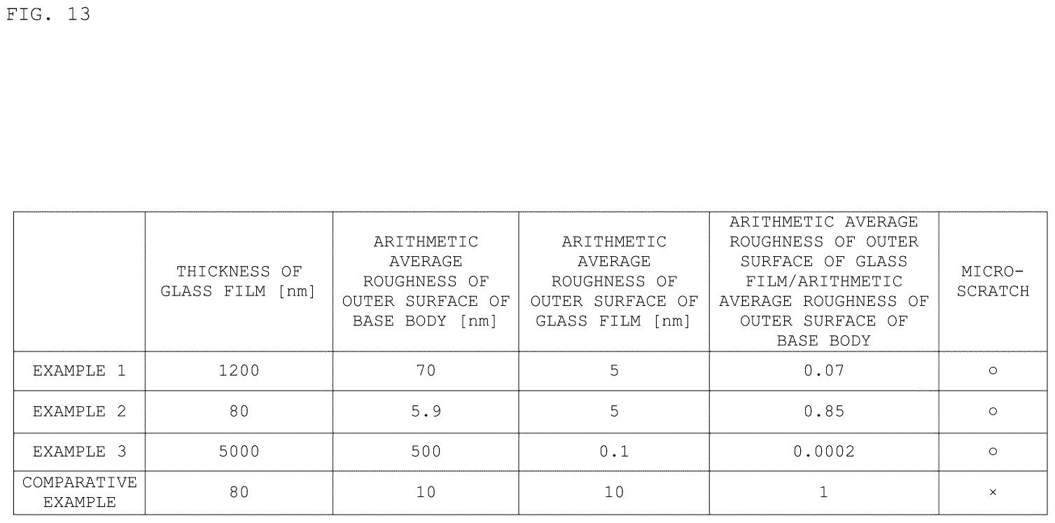

Next, as shown in FIG. 6, the immersing step S20 is performed. As shown in FIG. 12, in the immersing step S20, first, a solution 87 containing, as an additive, at least one element selected from an alkali metal and an alkaline earth metal is placed in advance in a reaction vessel 86 that is different from the reaction vessel 81 used up to the film forming step S18. The solution 87 is an aqueous solution containing a potassium oxide precursor. Then, the base bodies 20 with the glass film 50 in a gel form is immersed in the solution 87. Thus, the solution 87 adheres to the surface of the glass film 50.

Next, as shown in FIG. 6, the second drying step S21 is performed. In the second drying step S21, the base bodies 20 immersed in the solution 87 in the immersing step S20 are taken out from the reaction vessel 86 and then dried. Thus, the water of the solution 87 adhering to the surface of the glass film 50 is volatilized. In contrast, the potassium oxide precursor contained in the solution 87 is deposited on the outer surface 51 of the glass film 50.

Next, the conductor applying step S22 is performed. In the conductor applying step S22, a conductor paste is applied to two parts of the surface of the glass film 50: a part including a part that covers the first end surface 22A of the base body 20; and a part including a part that covers the second end surface 22B of the base body 20. Specifically, the conductor paste is applied so as to cover the glass film 50 on the whole region of the first end surface 22A and parts of the four side surfaces 22C. In addition, the conductor paste is applied so as to cover the glass film 50 on the whole region of the second end surface 22B and parts of the four side surfaces 22C.

Next, the curing step S23 is performed. Specifically, the base bodies 20 with the glass film 50 and conductor paste applied thereto are heated in the curing step S23. Thus, the deposited potassium oxide precursor becomes potassium oxide. The potassium oxide diffuses into the glass film 50 covering the outer surface 21 of the base body 20. Then, the vaporization of water and the polymer 84 from the glass film 50 in a gel form causes the glass film 50 covering the outer surface 21 of the base body 20 to be fired and cured. Furthermore, in the curing step S23, the conductor paste applied in the conductor applying step S22 is fired to form the first underlying electrode 61A and the second underlying electrode 62A.

At the time of heating in the curing step S23, palladium contained on the side with the first internal electrodes 41 is attracted toward the side with the first underlying electrode 61A containing silver by the Kirkendall effect caused from the difference in diffusion rate between the first internal electrodes 41 and the first underlying electrode 61A. Thus, the first penetrating parts 71 penetrate and extend through the glass film 50 from the first internal electrodes 41 toward the first underlying electrode 61A, thereby connecting the first internal electrodes 41 and the first underlying electrode 61A to each other. In this respect, the same applies to the second penetrating parts 72 that connect the second internal electrodes 42 and the second underlying electrode 62A to each other.

Next, the plating step S24 is performed. The parts of the first underlying electrode 61A and second underlying electrode 62A are subjected to electroplating. Thus, the first metal layer 61B is formed on the surface of the first underlying electrode 61A. In addition, the second metal layer 62B is formed on the surface of the second underlying electrode 62A. The first metal layer 61B and the second metal layer 62B each have a two-layer structure electroplated with two types: nickel and tin. In this manner, the electronic component 10 is formed.

### Results of Comparative Test

The electronic components 10 of Examples 1 to 3 and the electronic component of Comparative Example were subjected to a micro-scratch test.

The electronic component 10 of Example 1 has been described in the above discussion. That is, the average value of the thickness TG of the glass film 50 is 1200 nm. The arithmetic average roughness of the outer surface 21 of the base body 20 is 70 nm. The arithmetic average roughness of the outer surface 51 of the glass film 50 is 5 nm. The ratio of the arithmetic average roughness of the outer surface 51 of the glass film 50 is about 0.07 with respect to the arithmetic average roughness of the outer surface 21 of the base body 20.

The structure of the electronic component 10 of Examples 2 and 3 is similar to those described in the above-described Example 1. However, the thickness TG of the glass film 50, the arithmetic average roughness of the outer surface 21 of the base body 20, and the arithmetic average roughness of the outer surface 51 of the glass film 50 are different.

Specifically, in the electronic component 10 of Example 2, the average value of the thicknesses TG of the glass film 50 is 80 nm. The arithmetic average roughness of the outer surface 21 of the base body 20 is 5.9 nm. The arithmetic average roughness of the outer surface 51 of the glass film 50 is 5 nm. The ratio of the arithmetic average roughness of the outer surface 51 of the glass film 50 is about 0.85 with respect to the arithmetic average roughness of the outer surface 21 of the base body 20.

In the electronic component 10 of Example 3, the average value of the thickness TG of the glass film 50 is 5000 nm. The arithmetic average roughness of the outer surface 21 of the base body 20 is 500 nm. The arithmetic average roughness of the outer surface 51 of the glass film 50 is 0.1 nm. The ratio of the arithmetic average roughness of the outer surface 51 of the glass film 50 is about 0.0002 with respect to the arithmetic average roughness of the outer surface 21 of the base body 20.

The arithmetic average roughness of the outer surface 21 of the base body 20 can be adjusted by changing the conditions of the R chamfering step S12 of the manufacturing method described above. In addition, the thickness TG of the glass film 50 and the arithmetic average roughness of the outer surface 51 can be adjusted as in each Example by changing the time conditions of the film forming step S18, the concentration of the additive in the immersing step S20, and the like.

The structure of the electronic component of Comparative Example is similar to those described in the above-described examples. However, the thickness TG of the glass film 50, the arithmetic average roughness of the outer surface 21 of the base body 20, and the arithmetic average roughness of the outer surface 51 of the glass film 50 are different.

Specifically, in the electronic component of Comparative Example, the average value of the thickness TG of the glass film 50 is 80 nm. The arithmetic average roughness of the outer surface 21 of the base body 20 is 10 nm. The arithmetic average roughness of the outer surface 51 of the glass film 50 is 10 nm. The ratio of the arithmetic average roughness of the outer surface 51 of the glass film 50 is 1 with respect to the arithmetic average roughness of the outer surface 21 of the base body 20.

The electronic component of Comparative Example was manufactured without performing the immersing step S20 and the second drying step S21 in the above-described manufacturing method. That is, the glass film 50 of the electronic component of Comparative Example contains neither an alkali metal nor an alkaline earth metal as an additive.

For the electronic components 10 of Examples 1 to 3 and the electronic component of Comparative Example, the durability of the glass film 50 was evaluated by a micro-scratch test. In the evaluation of the micro-scratch test, 400 μm scanning is performed with a load of 100 mN using a diamond needle whose tip has a curvature radius of 25 μm. When no scratch was made, it was determined as pass, and when a scratch was made, it was determined as fail. In FIG. 13, “o” indicates pass, and “x” indicates fail.

As shown in FIG. 13, the electronic components 10 of Examples 1 to 3 were evaluated as pass in the micro-scratch test. On the other hand, the electronic component of Comparative Example was evaluated as fail in the micro-scratch test. From the test results, it has been found that the arithmetic average roughness of the outer surface 51 of the glass film 50 is preferably smaller than the arithmetic average roughness of the outer surface 21 of the base body 20 from the viewpoint of the durability of the glass film 50. In particular, it has been found that the micro-scratch test can be passed when the ratio of the arithmetic average roughness of the outer surface 51 of the glass film 50 is 0.0002 or more and 0.85 or less with respect to the arithmetic average roughness of the outer surface 21 of the base body 20. In addition, it has been found that the micro-scratch test can be passed when the average value of the thickness TG of the glass film 50 is as thin as less than 5000 nm, as long as the condition of arithmetic average roughness is satisfied.

### Technical Effects

(1) A ratio of the arithmetic average roughness of the outer surface 51 of the glass film 50 to the arithmetic average roughness of the outer surface 21 of the base body 20 is 0.0002 or more and 0.85 or less. That is, the outer surface 51 of the glass film 50 is smooth compared to the outer surface 21 of the base body 20. Therefore, when the outer surface 51 of the glass film 50 is rubbed against another object, it is possible to reduce frictional force to be generated on the outer surface 51 of the glass film 50. Therefore, the glass film 50 is less likely to be damaged, for example, cracked and chipped. On the other hand, the outer surface 21 of the base body 20 is rougher than the outer surface 51 of the glass film 50. Therefore, sufficient adhesion force is obtained between the base body 20 and the glass film 50.
(2) The thickness TG of the glass film 50 is 80 nm or more and 5000 nm or less. When the thickness TG of the glass film 50 is thin as described above, interface stress is less likely to occur between the base body 20 and the glass film 50. Therefore, the glass film 50 is hardly peeled off from the base body 20.
(3) The arithmetic average roughness of the outer surface 51 of the glass film 50 is 0.1 nm or more and 5 nm or less. That is, the outer surface 51 of the glass film 50 is considerably smooth. As a result, frictional force to be generated on the outer surface 51 of the glass film 50 is reduced. Therefore, the outer surface 51 of the glass film 50 is less likely to be scratched.
(4) The arithmetic average roughness of the outer surface 21 of the base body 20 is 5.9 nm or more and 500 nm or less. When the outer surface 21 of the base body 20 has unevenness to some extent as described above, an anchor effect is generated between the base body 20 and the glass film 50. Therefore, adhesiveness between the base body 20 and the glass film 50 is enhanced.
(5) Since the first underlying electrode 61A contains glass, the glass component of the first underlying electrode 61A is diffused into and integrated with the glass film 50. As a result, while the outer surface 51 of the glass film 50 is smooth, adhesion to the first underlying electrode 61A can also be secured. In this respect, the same applies to the second underlying electrode 62A.
(6) The glass film 50 contains, as an additive, one or more elements selected from an alkali metal and an alkaline earth metal, and the ratio of the additive to Si contained in the glass film 50 is 0.5 atm % or more and 90 atm % or less. When the additive is contained within the range of this ratio, a part of the recess 23 present in the outer surface 21 of the base body 20 is filled with the glass film 50. Consequently, the outer surface 51 of the glass film 50 becomes smoother.

### Modification

The above-mentioned examples and the following modifications can be implemented in combination within a range that is not technically contradictory.
The electronic component 10 is not limited to any negative-characteristic thermistor component. For example, the electronic component 10 may be a thermistor component other than those that have negative characteristics, or may be a multilayer capacitor component or an inductor component, as long as the electronic component 10 includes some wiring inside the base body 20.
The material of the base body 20 is not limited to the above example. The material of the base body 20 may be a composite of a resin and a metal powder.
The shape of the base body 20 is not limited to the above example. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.
In the outer surface 21 of the base body 20, a boundary portion between the adjacent planar surfaces 22 does not necessarily have a chamfered shape. In this case, there is no curved surface at the boundary portion.
The shape of the first internal electrode 41 and the second internal electrode 42 is not limited as long as it can ensure electrical conduction with the corresponding first external electrode 61 and second external electrode 62. In addition, the number of the first internal electrode 41 and the number of the second internal electrode 42 are not limited, and the number of the internal electrode may be one or may be three or more.
The configuration of the first external electrode 61 is not limited to the example mentioned above. For example, the first external electrode 61 may include only the first underlying electrode 61A, or the first metal layer 61B may have no two-layer structure. In this respect, the same applies to the second external electrode 62.
The first underlying electrode 61A is only electrically conductive with the first internal electrode 41, and may contain no glass. Similarly, the second underlying electrode 62A is only electrically conductive with the second internal electrode 42, and may contain no glass.
The material combination of the first internal electrode 41 and the first underlying electrode 61A is not limited to the combination of palladium and silver. The combination may be, for example, a combination of copper and nickel, copper and silver, silver and gold, nickel and cobalt, or nickel and gold. For example, one may be silver, and the other may be a combination of silver and palladium. For example, one may be palladium, and the other may be a combination of silver and palladium. Alternatively, one may be copper, and the other may be a combination of silver and palladium. For example, one may be gold, and the other may be a combination of silver and palladium.
Depending on the combination of the first internal electrode 41 and the first underlying electrode 61A, no Kirkendall effect may be achieved. In this case, the first internal electrode 41 may be processed to be exposed before the external electrode forming step. For example, a part of the glass film 50 may be physically removed by polishing the first end surface 22A side of the base body 20. Thereafter, the first internal electrode 41 and the first underlying electrode 61A can be connected by performing the underlying electrode forming step. Alternatively, for example, after the first underlying electrode 61A is formed, the glass film 50 is formed on a region including the surface of the first underlying electrode 61A, and the glass film 50 covering the surface of the first underlying electrode 61A is removed. In this respect, the same applies to the combination of the materials of the second internal electrode 42 and the second underlying electrode 62A.
The arrangement place of the first external electrode 61 is not limited to the above example. For example, the first external electrode 61 may be disposed only on the first end surface 22A and one of the side surfaces 22C. In this respect, the same applies to the second external electrode 62.
The glass film 50 does not have to cover substantially the entire region of the outer surface 21 of the base body 20. The range covered by the glass film 50 may be changed appropriately in accordance with the shape of the base body 20, the positions of the first external electrode 61 and the second external electrode 62, and the like.
As for the part of the glass film 50 covered with the first underlying electrode 61A, the glass in the glass film 50 may be diffused into and thus integrated with the glass in the first underlying electrode 61A.
When the glass film 50 contains, as an additive, one or more elements selected from an alkali metal and an alkaline earth metal, the ratio of the additive may be less than 0.5 atm %, or may be more than 90 atm %, with respect to Si contained in the glass film 50.
The material of the glass film 50 is not limited to the above example. For example, the glass is not limited to any silicon dioxide, and may be a multicomponent oxide containing Si, such as a B—Si-based, Si—Zn-based, Zr—Si-based, or Al—Si-based oxide. In addition, the glass may be a multicomponent oxide containing an alkali metal and Si, such as an Al—Si-based, Na—Si-based, or Li—Si-based oxide. Furthermore, the glass may be a multicomponent oxide containing an alkaline earth metal and Si, such as a Mg—Si-based, Ca—Si-based, Ba—Si-based, or Sr—Si-based oxide. The glass does not have to contain Si, and may be a mixture thereof.

The material of the glass film 50 may contain, in addition to glass, a pigment, a silicone-based flame retardant, a surface treatment agent such as a silane coupling agent and a titanate coupling agent, or an antistatic agent.

More specifically, the glass film 50 may contain, in addition to the glass, additives of fine particles and nanoparticles of organic acid salts, oxides, inorganic salts, organic salts, and other metal oxides. In addition, the additive contained in the solution 87 is not limited to the potassium oxide precursor.

Examples of the organic acid salt include salts of oxo acids such as soda ash, sodium carbonate, sodium hydrogen carbonate, sodium percarbonate, sodium sulfite, sodium hydrogen sulfite, sodium sulfate, sodium thiosulfate, sodium nitrate, and sodium sulfite, and halogen compounds such as sodium fluoride, sodium chloride, sodium bromide, and sodium iodide.

Examples of the oxide include sodium peroxide, and examples of the hydroxide include sodium hydroxide.

Examples of the inorganic salt include sodium hydride, sodium sulfide, sodium hydrogen sulfide, sodium silicate, trisodium phosphate, sodium borate, sodium borohydride, sodium cyanide, sodium cyanate, and sodium tetrachloroaurate.

Examples of the inorganic salt include calcium peroxide, calcium hydroxide, calcium fluoride, calcium chloride, calcium bromide, calcium iodide, calcium hydride, calcium carbide, and calcium phosphide.

The additive may be an oxoacid salt such as calcium carbonate, calcium hydrogen carbonate, calcium nitrate, calcium sulfate, calcium sulfite, calcium silicate, calcium phosphate, calcium pyrophosphate, calcium hypochlorite, calcium chlorate, calcium perchlorate, calcium bromate, calcium iodate, calcium arsenite, calcium chromate, calcium tungstate, calcium molybdate, calcium magnesium carbonate, or hydroxyapatite. Examples of the additive include calcium acetate, calcium gluconate, calcium citrate, calcium malate, calcium lactate, calcium benzoate, calcium stearate, and calcium aspartate.

For example, the additive may be lithium carbonate, lithium chloride, lithium titanate, lithium nitride, lithium peroxide, lithium citrate, lithium fluoride, lithium hexafluorophosphate, lithium acetate, lithium iodide, lithium hypochlorite, lithium tetraborate, lithium bromide, lithium nitrate, lithium hydroxide, lithium aluminum hydride, lithium triethylborohydride, lithium hydride, lithium amide, lithium imide, lithium diisopropylamide, lithium tetramethylpiperidide, lithium sulfide, lithium sulfate, lithium thiophenolate, or lithium phenoxide.

For example, the additive may be boron triiodide, sodium cyanoborohydride, sodium borohydride, tetrafluoroboric acid, triethylborane, borax, or boric acid.

For example, the additive may be barium sulfite, barium chloride, barium chlorate, barium perchlorate, barium peroxide, barium chromate, barium acetate, barium cyanide, barium bromide, barium oxalate, barium nitrate, barium hydroxide, barium hydride, barium carbonate, barium iodide, barium sulfide, or barium sulfate. In addition, the additive may be sodium acetate or sodium citrate.

The additive may be fine particles or nanoparticles of a metal oxide, and examples of the metal oxide include sodium oxide, calcium oxide, lithium oxide, boron oxide, barium oxide, silicon oxide, titanium oxide, zircon oxide, aluminum oxide, zinc oxide, and magnesium oxide.

In addition, as mentioned above, examples of the potassium oxide precursor include potassium arsenide, potassium bromide, potassium carbide, potassium chloride, potassium fluoride, potassium hydride, potassium iodide, potassium triiodide, potassium azide, potassium nitride, potassium superoxide, potassium ozonide, potassium peroxide, potassium phosphide, potassium sulfide, potassium selenide, potassium telluride, potassium tetrafluoroaluminate, potassium tetrafluoroborate, potassium tetrahydroborate, potassium methanide, potassium cyanide, potassium formate, potassium hydrogen fluoride, potassium tetraiodomercurate (II), potassium hydrogen sulfide, potassium octachlorodimolybdate (II), potassium amide, potassium hydroxide, potassium hexafluorophosphate, potassium carbonate, potassium tetrachloroplatinate (II), potassium hexachloroplatinate (IV), potassium nonahydridorhenate (VII), potassium sulfate, potassium acetate, gold (I) potassium cyanide, potassium hexanitritocobaltate (III), potassium hexacyanoferrate (III), potassium hexacyanoferrate (II), potassium methoxide, potassium ethoxide, potassium tert-butoxide, potassium cyanate, potassium fulminate, potassium thiocyanate, potassium aluminum sulfate, potassium aluminate, potassium arsenate, potassium bromate, potassium hypochlorite, potassium chlorite, potassium chlorate, potassium perchlorate, potassium carbonate, potassium chromate, potassium dichromate, potassium tetrakis (peroxo) chromate (V), potassium cuprate (III), potassium ferrate, potassium iodate, potassium periodate, potassium permanganate, potassium manganate, potassium hypomanganate, potassium molybdate, potassium nitrite, potassium nitrate, tripotassium phosphate, potassium perrhenate, potassium selenate, potassium silicate, potassium sulfite, potassium sulfate, potassium thiosulfate, potassium disulfite, potassium dithionate, potassium disulfate, potassium peroxodisulfate, potassium dihydrogenarsenate, dipotassium hydrogen arsenate, potassium hydrogen carbonate, potassium dihydrogen phosphate, dipotassium hydrogen phosphate, potassium hydrogen selenate, potassium hydrogen sulfite, potassium hydrogen sulfate, and potassium hydrogen peroxosulfate.

The metal alkoxide 85 may be, for example, sodium methoxide, sodium ethoxide, calcium diethoxide, lithium isopropoxide, lithium ethoxide, lithium tert-butoxide, lithium methoxide, boron alkoxide, potassium t-butoxide, tetraethyl orthosilicate, allyltrimethoxysilane, isobutyl(trimethoxy)silane, tetrapropyl orthosilicate, tetramethyl orthosilicate, [3-(diethylamino)propyl]trimethoxysilane, triethoxy(octyl)silane, triethoxyvinylsilane, triethoxyphenylsilane, trimethoxyphenylsilane, trimethoxymethylsilane, butyltrichlorosilane, n-propyltriethoxysilane, methyltrichlorosilane, dimethoxy(methyl)octylsilane, dimethoxydimethylsilane, tris(tert-butoxy)silanol, tris(tert-pentoxy)silanol, hexadecyltrimethoxysilane, dipotassium tris(1,2-benzenediolato-O,O′) silicate, tetrabutyl orthosilicate, aluminum silicate, calcium silicate, a tetramethylammonium silicate solution, chlorotriisopropoxytitanium (IV), titanium (IV) isopropoxide, titanium (IV) 2-ethylhexyl oxide, titanium (IV) ethoxide, titanium (IV) butoxide, titanium (IV) tert-butoxide, titanium (IV) propoxide, titanium (IV) methoxide, zirconium (IV) bis (diethyl citrato) dipropoxide, zirconium (IV) dibutoxide (bis-2,4-pentanedionate), zirconium (IV) 2-ethylhexanoate, a zirconium (IV) isopropoxide isopropanol complex, zirconium (IV) ethoxide, zirconium (IV) butoxide, zirconium (IV) tert-butoxide, zirconium (IV) propoxide, aluminum tert-butoxide, aluminum isopropoxide, aluminum ethoxide, aluminum-tri-sec-butoxide, or aluminum phenoxide.
The arithmetic average roughness of the outer surface 51 of the glass film 50 may be less than 0.1 nm. That is, the outer surface 51 of the glass film 50 may be smoother than the example described above. The arithmetic average roughness of the outer surface 51 of the glass film 50 may be larger than 5 nm. The present disclosure makes it possible to reduce the arithmetic average roughness of the outer surface 51 of the glass film 50 with respect to the arithmetic average roughness of the outer surface 21 of the base body 20, compared to the case where the glass film 50 contains no additive. Thereby, the effect described in (1) can be obtained.
The arithmetic average roughness of the outer surface 21 of the base body 20 may be less than 5.9 nm or may be greater than 500 nm. When the outer surface 51 of the glass film 50 is sufficiently smooth compared to the roughness of the outer surface 21 of the base body 20, the effect described in (1) can be obtained.
The method for measuring the arithmetic average roughness of the outer surface 51 of the glass film 50 and the arithmetic average roughness of the outer surface 21 of the base body 20 is not limited to the above example. For example, each arithmetic average roughness may be obtained as follows: the section of the base body 20 is captured with an electron microscope, and the captured image is subjected to image analysis within a range of at least 10 μm or more in a direction along the outer surface 51 of the glass film 50. When the roughness of the outer surface 21 of the base body 20 is not substantially constant as a whole, the outer surface 51 of the glass film 50 and the outer surface 21 of the base body 20 may be measured at substantially the same portion to obtain each arithmetic average roughness by the above method.
When the arithmetic average roughness of the outer surface 51 of the glass film 50 and the arithmetic average roughness of the outer surface 21 of the base body 20 are measured, instruments such as a white interferometer, an atomic force microscope, and a stylus profiling system may be used instead of a laser microscope. In addition, the instrument to measure the arithmetic average roughness of the outer surface 51 of the glass film 50 and the instrument to measure the arithmetic average roughness of the outer surface 21 of the base body 20 may be non-identical to each other. For example, the arithmetic average roughness of the outer surface 51 of the glass film 50 is measured using a white interferometer, and the arithmetic average roughness of the outer surface 21 of the base body 20 is measured using a laser microscope.

### Supplementary Note

Technical ideas that can be derived from the above discussion and modifications will be described below.

[1]

An electronic component including: a base body; and a glass film covering an outer surface of the base body, wherein
the glass film contains one or more elements selected from an alkali metal and an alkaline earth metal as an additive,
the glass film has a thickness of, as an average value, 80 nm or more and 5000 nm or less, and
a ratio of an arithmetic average roughness of an outer surface of the glass film to an arithmetic average roughness of an outer surface of the base body is 0.0002 or more and 0.85 or less.
   [2]

The electronic component according to [1], wherein the arithmetic average roughness of the outer surface of the glass film is 0.1 nm or more and 5 nm or less.

[3]

The electronic component according to [1] or [2], wherein the arithmetic average roughness of the outer surface of the base body is 5.9 nm or more and 500 nm or less.

[4]

The electronic component according to any one of [1] to [3], further including an underlying electrode partly covering the glass film, wherein
the underlying electrode contains glass.
   [5]

The electronic component according to any one of [1] to [4], wherein a ratio of the additive to Si contained in the glass film is 0.5 atm % or more and 90 atm % or less.

### DESCRIPTION OF REFERENCE SYMBOLS

10: Electronic component
20: Base body
50: Glass film
51: Outer surface
TG: Thickness

1. An electronic component, comprising:
a base body; and
a glass film covering an outer surface of the base body, wherein
the glass film contains one or more elements selected from an alkali metal and an alkaline earth metal as an additive,
the glass film has a thickness of 80 nm or more and 5000 nm or less, and
a ratio of an arithmetic average roughness of an outer surface of the glass film to an arithmetic average roughness of the outer surface of the base body is 0.0002 or more and 0.85 or less.

2. The electronic component according to claim 1, wherein the arithmetic average roughness of the outer surface of the glass film is 0.1 nm or more and 5 nm or less.

3. The electronic component according to claim 1, wherein the arithmetic average roughness of the outer surface of the base body is 5.9 nm or more and 500 nm or less.

4. The electronic component according to claim 2, wherein the arithmetic average roughness of the outer surface of the base body is 5.9 nm or more and 500 nm or less.

5. The electronic component according to claim 1, further comprising:
an underlying electrode at least partly covering the glass film, wherein
the underlying electrode contains glass.

6. The electronic component according to claim 2, further comprising:
an underlying electrode at least partly covering the glass film, wherein
the underlying electrode contains glass.

7. The electronic component according to claim 3, further comprising:
an underlying electrode at least partly covering the glass film, wherein
the underlying electrode contains glass.

8. The electronic component according to claim 1, wherein
the glass film contains Si, and
a ratio of the additive to the Si contained in the glass film is 0.5 atm % or more and 90 atm % or less.

9. The electronic component according to claim 2, wherein
the glass film contains Si, and
a ratio of the additive to the Si contained in the glass film is 0.5 atm % or more and 90 atm % or less.

10. The electronic component according to claim 3, wherein
the glass film contains Si, and
a ratio of the additive to the Si contained in the glass film is 0.5 atm % or more and 90 atm % or less.

11. The electronic component according to claim 5, wherein
the glass film contains Si, and
a ratio of the additive to the Si contained in the glass film is 0.5 atm % or more and 90 atm % or less.

12. The electronic component according to claim 1, wherein the thickness of the glass film is an average value thickness of 80 nm or more and 5000 nm or less.

13. A thermistor, comprising:
the electronic component according to claim 1, wherein
a resistance value of the thermistor decreases as a temperature of the thermistor increases.

14. A thermistor, comprising the electronic component according to claim 1.

15. An inductor, comprising:
a wiring; and
the electronic component according to claim 1, wherein
the wiring is inside of the base body.

16. The electronic component according to claim 1, wherein the base body is composed of a resin and a metal powder.

17. The electronic component according to claim 5, wherein the glass film is diffused into and integrated with the underlying electrode.

18. The electronic component according to claim 1, wherein the glass film is a multicomponent oxide containing Si, such as a B—Si-based, Si—Zn-based, Zr—Si-based, or Al—Si-based oxide.

19. The electronic component according to claim 1, wherein the glass film is a multicomponent oxide containing an alkali metal and Si, such as an Al—Si-based, Na—Si-based, or Li—Si-based oxide.

20. The electronic component according to claim 1, wherein the glass film is a multicomponent oxide containing an alkaline earth metal and Si, such as a Mg—Si-based, Ca—Si-based, Ba—Si-based, or Sr—Si-based oxide.
